(19) United States
(12) Patent Application Publication
(10) Pub. No.: US 2006/0233099 A1
(43) Pub. Date: Oct. 19, 2006

(54) Method and apparatus for enabling dynamic increase in call and service processing capacity

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/109,097

(22) Filed: Apr. 19, 2005

(51) Int. Cl. H04J 3/14; H04J 1/16; H04L 12/66

(52) U.S. Cl. 370/218; 370/235; 370/352

(57) ABSTRACT

A method and apparatus for enabling dynamic resource allocations in a packet network is disclosed. In one embodiment, the method allows for the activation of one or more hot standby components on a per network element basis when calling volume and/or service feature usage load increases approach or exceed a specified capacity threshold.

The present invention relates generally to communication networks and, more particularly, to a method and apparatus for enabling dynamic increase in call and service processing capacity in packet networks, e.g. Voice over Internet Protocol (VoIP) networks.

### BACKGROUND OF THE INVENTION

Network providers can experience sudden increases in call volumes due to mass calling events and other social phenomena that trigger a need for voice communication. Most networks are engineered to adequately handle traffic that occurs during the typical busy hour and with known subscriber forecasts. Volumes that greatly exceed these engineered capacities typically result in service degradations or even disruptions. In order to handle the unexpected increase of call traffic or service feature usage load, additional network resources need to be added dynamically to cope with the increase.

Therefore, a need exists for a method and apparatus for enabling dynamic increase in call and service processing capacity in a packet network, e.g., a VoIP network.

### SUMMARY OF THE INVENTION

In one embodiment, the present invention enables dynamic resource allocations in a packet network, e.g., a VoIP network. In one embodiment, the present invention allows for the activation of hot standby components on a per network element basis when calling volume or service feature usage load increases approach a specified capacity threshold.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of collecting call volume and service feature usage performance data in a VoIP network of the present invention;

FIG. 3 illustrates a flowchart of a method for enabling dynamic increase in call and service processing capacity in a VoIP network of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

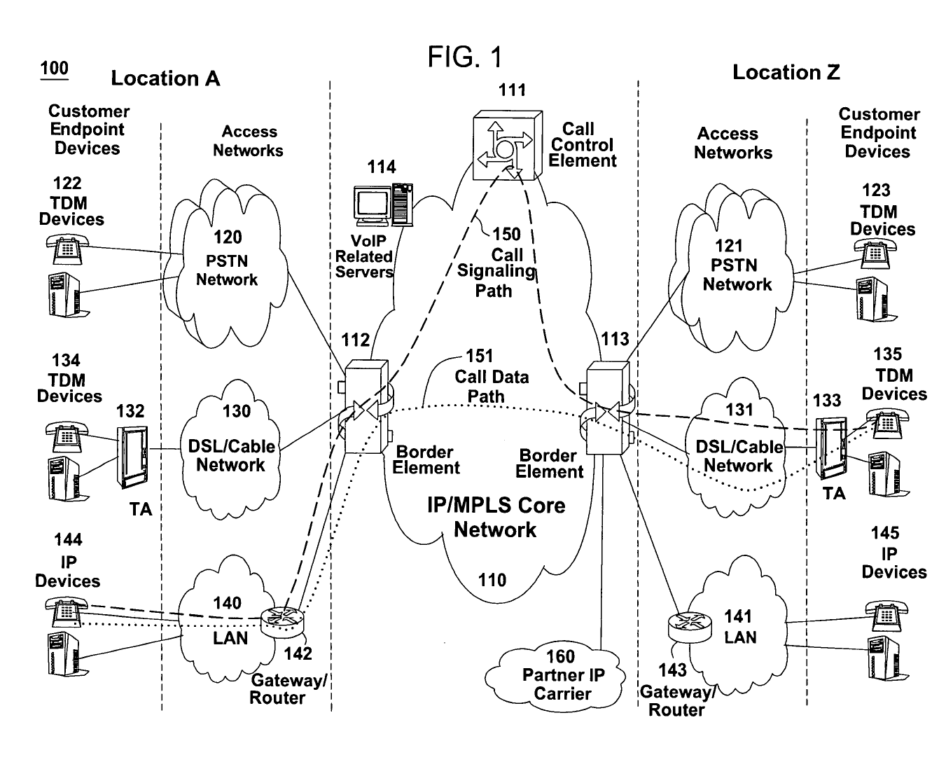

To better understand the present invention, FIG. 1 illustrates an example network, e.g., a packet network such as a VoIP network related to the present invention. Exemplary packet networks include Internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122,123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact With various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Network providers, e.g., VoIP network providers, can experience sudden increases in call volumes due to mass calling events and other social phenomena that trigger a need for voice communication. Volumes that greatly exceed these engineered capacities typically result in service degradations or even disruptions. In order to handle the unexpected increase of call traffic or service feature usage load, additional network resources need to be added dynamically to cope with the increase.

To address this need, the present invention enables dynamic resource allocations in a packet network, e.g., a VoIP network. In one embodiment, the present invention allows for the activation of hot standby components on a per network element basis when calling volume or service feature usage load increases approach a specified capacity threshold. A hot standby component is a secondary component which is running simultaneously with the primary component that can, within a very short period of time (e.g., in the range of mili-seconds), be switched over to backup or augment the primary component. When used in the backup mode, the hot stanby component can simply take over the function of the primary component if the primary component fails. When used in the augmentation mode, the hot standby component can augment the processing capacity of the primary component when the primary component is getting overloaded.

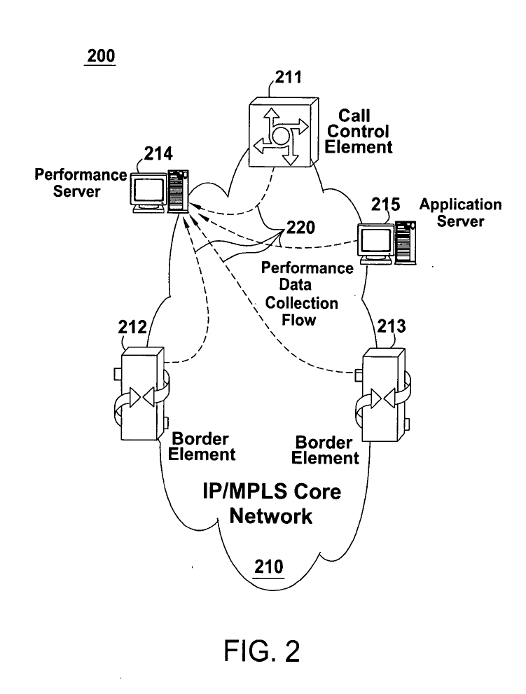

FIG. 2 illustrates an example of collecting call volume and service feature usage performance data in a packet network 210, e.g., a VoIP network. In FIG. 2, performance data related to call volume and service feature usage load is collected from all network elements, such as CCE 211, BE 212, BE 213, and AS 215, within the network by Performance Server (PS) 214 as shown in performance data collection flow 220. The call volume and service usage performance data is collected from network elements including, but are not limited to, CCE, BE, and AS. It should be noted that the number of network elements shown in FIG. 2 is only exemplary. Any number of network elements can be monitored for call volume and service feature usage.

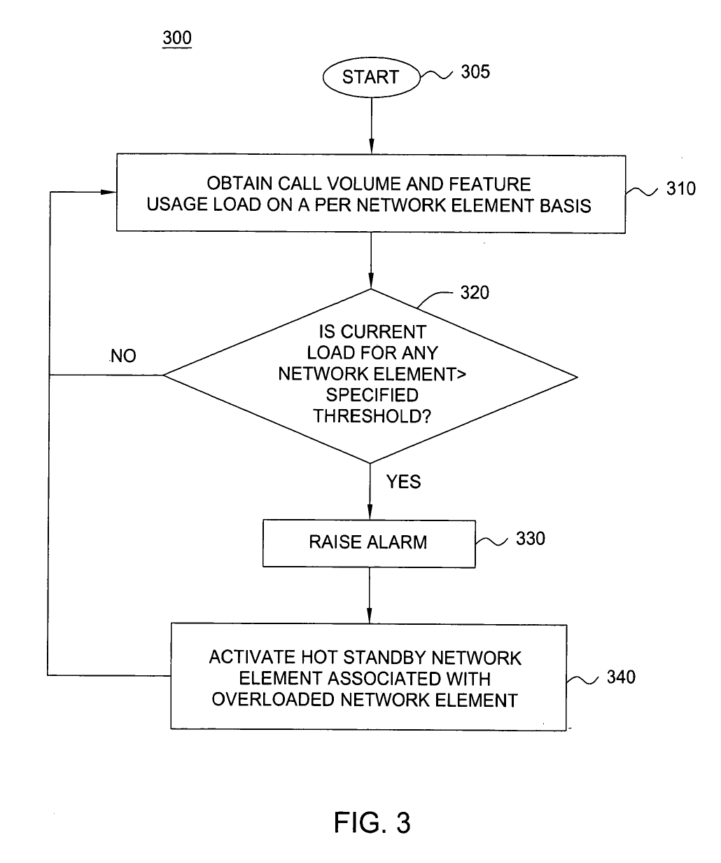

FIG. 3 illustrates a flowchart of a method 300 for enabling dynamic increase in call and service processing capacity in a packet network e.g., a VoIP network. Method 300 starts in step 305 and proceeds to step 310.

In step 310, the method 300 obtains usage load, e.g., call volume and/or service usage load, on a per network element basis for each network element in the network. In step 320, the method checks if the current call volume and service usage load for any network element has exceeded the pre-specified capacity threshold set by the network provider. If the pre-specified capacity threshold set by the network provider is exceeded, the method proceeds to step 330; otherwise, the method proceeds to step 310. In step 330, the method raises an alarm to warn the network provider that overload conditions are being experienced by one or more specific network elements in the network. In step 340, the method activates hot standby network elements that are associated with the overloaded network elements to relieve the load of the overloaded network elements. More importantly, the method helps prevent potential network service disruption by dynamically increasing processing capacity on a per network element basis in the network. Then, the method proceeds back to step 310.

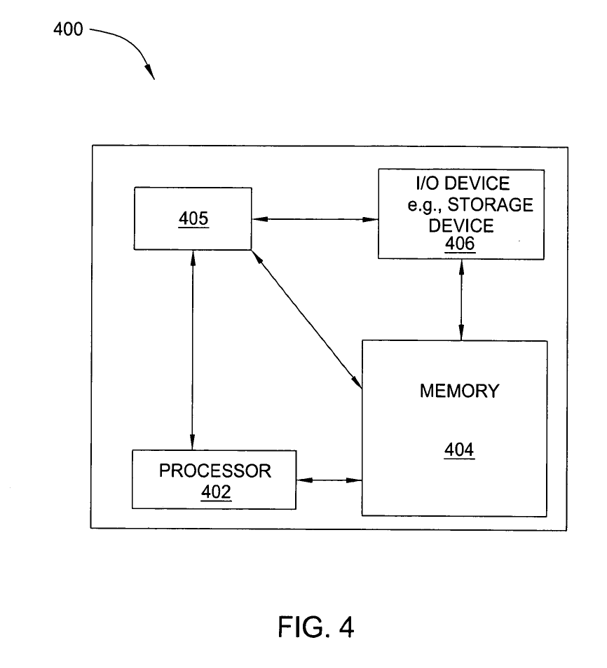

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a dynamic increase in call and service processing capacity module 405, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present dynamic increase in call and service processing capacity module or process 405 can be loaded into memory 404 and executed by processor 402 to implement the functions as discussed above. As such, the present dynamic increase in call and service processing capacity process 405 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for increasing processing capacity dynamically in a communication network, comprising:
monitoring usage load on a plurality of network elements in said communication network, where said usage load is monitored on a per network element basis; and
raising an alarm indication if said load usage of at least one of said plurality of network elements exceeds its corresponding pre-defined threshold.

2. The method of claim 1, wherein said communication network is a Voice over Internet Protocol (VoIP) network or a SoIP (Service over Internet Protocol) network.

3. The method of claim 1, wherein said usage load is monitored on a per network element basis by a Performance Server (PS).

4. The method of claim 1, wherein said corresponding pre-defined threshold is selectively set by a provider of said communication network.

5. The method of claim 1, wherein said alarm is raised by a Performance Server.

6. The method of claim 1, further comprises:
activating at least one hot standby network element that is associated with at least one overloaded network element identified in accordance with said alarm indication.

7. The method of claim 1, wherein said load usage comprises at least one of: a call volume usage and a service feature usage.

8. A computer-readable medium having stored thereon a plurality of instructions, the plurality of instructions including instructions which, when executed by a processor, cause the processor to perform the steps of a method for increasing processing capacity dynamically in a communication network, comprising:
monitoring usage load on a plurality of network elements in said communication network, where said usage load is monitored on a per network element basis; and
raising an alarm indication if said load usage of at least one of said plurality of network elements exceeds its corresponding pre-defined threshold.

9. The computer-readable medium of claim 8, wherein said communication network is a Voice over Internet Protocol (VoIP) network or a SoIP (Service over Internet Protocol) network.

10. The computer-readable medium of claim 8, wherein said usage load is monitored on a per network element basis by a Performance Server (PS).

11. The computer-readable medium of claim 8, wherein said corresponding pre-defined threshold is selectively set by a provider of said communication network.

12. The computer-readable medium of claim 8, wherein said alarm is raised by a Performance Server.

13. The computer-readable medium of claim 8, further comprises:
activating at least one hot standby network element that is associated with at least one overloaded network element identified in accordance with said alarm indication.

14. The computer-readable medium of claim 8, wherein said load usage comprises at least one of: a call volume usage and a service feature usage.

15. An apparatus for increasing processing capacity dynamically in a communication network, comprising:
means for monitoring usage load on a plurality of network elements in said communication network, where said usage load is monitored on a per network element basis; and
means for raising an alarm indication if said load usage of at least one of said plurality of network elements exceeds its corresponding pre-defined threshold.

16. The apparatus of claim 15, wherein said communication network is a Voice over Internet Protocol (VoIP) network or a SoIP (Service over Internet Protocol) network.

17. The apparatus of claim 15, wherein said usage load is monitored on a per network element basis by a Performance Server (PS).

18. The apparatus of claim 15, wherein said alarm is raised by a Performance Server.

19. The apparatus of claim 15, further comprises:
means for activating at least one hot standby network element that is associated with at least one overloaded network element identified in accordance with said alarm indication.

20. The apparatus of claim 15, wherein said load usage comprises at least one of: a call volume usage and a service feature usage.
